(19) United States
(12) Patent Application Publication
(10) Pub. No.: US 2011/0174438 A1
(43) Pub. Date: Jul. 21, 2011

(54) ADHESIVE IMPREGNATED CARRIER

(76) Inventor: James D. Lockwood, Boulder, CO (US)

(21) Appl. No.: 13/009,993

(22) Filed: Jan. 20, 2011

Related U.S. Application Data
(63) Continuation of application No. 11/679,451, filed on Feb. 27, 2007, now abandoned.
(60) Provisional application No. 60/777,067, filed on Feb. 27, 2006.

(51) Int. Cl. B32B 37/12; B32B 37/02; B32B 37/14; B05D 5/10; B32B 7/12

(52) U.S. Cl. 156/308.6; 156/308.2; 427/207.1; 428/343; 428/355 R; 428/355 EP; 428/355 AC; 428/355 N

(57) ABSTRACT

An adhesive impregnated carrier comprising a carrier impregnated with uncured adhesive resin is provided. The carrier material and overall impregnated carrier can be any desired thickness, as further described herein. Also provided is a method of bonding materials together comprising: positioning an uncured adhesive impregnated carrier between materials to be bonded; and curing the adhesive impregnated carrier, wherein the materials are bonded.

### CROSS-REFERENCE TO RELATED APPLICATIONS

This application takes priority from U.S. provisional application Ser. No. 60/777,067, filed Feb. 27, 2006, which is incorporated by reference herein.

### BACKGROUND OF THE INVENTION

The common method for bonding two surfaces together at ambient temperature is to apply adhesive liquid or paste to one or both surfaces and press them together before the adhesive starts curing. This process requires the user to establish the thickness of the bond line before and after clamping the surfaces together and to remove excess adhesive that extrudes from the bonded surfaces following clamping. This common technique applies to all ambient cured adhesives including one part household glue, two part epoxies and urethane adhesives.

The existing methods of dispensing, applying and bonding two surfaces using conventional adhesive liquid or paste have several disadvantages. The application requires a hand or a brush to apply the liquid or paste and can contaminate adjacent surfaces with adhesive. Furthermore, it is difficult to control the bond line thickness and that, in turn, affects the strength of the bond. Additional problems exist with respect to conventional adhesives because the dispensers typically become clogged with cured adhesive following their use.

Another approach for bonding two surfaces together is the use of double-sided tapes. Konishi (U.S. Pat. No. 4,844,973) describes a porous tape support which is coated on both sides by a pressure-sensitive adhesive solution or suspension and then dried by heating. LeCompte (U.S. Pat. No. 3,723,223) describes a carrier which is impregnated with a room-temperature solid epoxy resin, a room-temperature solid curing agent for the epoxy resin, a binder, and a dispersing agent, then dried. When used, the treated carrier is heated and pressure-treated to cure the epoxy resin.

An improved method of bonding two surfaces together at room temperature and without the requirement of pressure to cure is the basis of the invention.

### SUMMARY OF THE INVENTION

The present invention overcomes the foregoing problems, while providing additional advantages. The invention includes two components; a carrier component (which may be a strip or sheet), and an uncured adhesive resin. The uncured adhesive resin may be in liquid or paste form, for example, or any other suitable form. The carrier component is impregnated with the adhesive resin in any suitable method (one example is shown in FIG. 1). The carrier component acts as a support matrix for the uncured adhesive resin and imparts little or no structural strength to the bond that results after the adhesive resin cures. The adhesive-impregnated carrier differs from a conventional double-sided adhesive tape in that the adhesive resin is soaked through the carrier component, interpenetrating the carrier with a continuous layer of resin throughout. Therefore, when the impregnated carrier is allowed to cure between two surfaces to be bonded together, the cured resin constitutes a continuous layer from one bonded surface to the other.

More specifically, provided is an adhesive impregnated carrier comprising a carrier impregnated with uncured adhesive resin. The carrier itself and adhesive impregnated carrier can be any desired thickness, such as from 1/64 inch and 1/16 inch, as further described herein. Also provided is an adhesive impregnated carrier comprising a carrier impregnated with uncured adhesive resin, further comprising a bag or barrier surrounding the carrier. The barrier may be a sealed package to protect the uncured adhesive resin from the conditions which result in curing. For example, the barrier may be a moisture-resistant package for water-cured adhesive resin.

Also provided is a method of bonding materials together comprising: positioning an uncured adhesive impregnated carrier between materials to be bonded; and curing the adhesive impregnated carrier, wherein the materials are bonded. In one embodiment, the curing step comprises moistening the surfaces the adhesive impregnated carrier is bonded to. In one embodiment, the curing step comprises moistening the adhesive impregnated carrier.

Also provided is a method of preparing an adhesive impregnated carrier comprising: impregnating a carrier with uncured water-curable adhesive resin. In one embodiment of this method, the adhesive impregnated carrier is impregnated off site using urethane adhesive packaged in water (moisture) impervious bags (such as foil bags) until used.

Also provided is a method of preparing an adhesive impregnated carrier comprising: impregnating a carrier with uncured adhesive such as pre-mixed two part epoxy or one part non-urethane adhesive. In this method, the carrier may be impregnated off site or on site and may be used in a production line.

### BRIEF DESCRIPTION OF THE FIGURES

FIG. 1 illustrates one embodiment of impregnating the carrier with adhesive resin.

FIG. 2 illustrates a thin bond line used for smooth surfaces, for example.

FIG. 3 illustrates a thicker bond line used for rough surfaces, for example.

FIG. 4 illustrates a roll of uncured adhesive impregnated carrier.

FIG. 5 illustrates overlapping layers of uncured adhesive impregnated carrier for packaging.

FIG. 6 illustrates bonding materials at an angle.

FIG. 7 illustrates tearing or cutting of excess material.

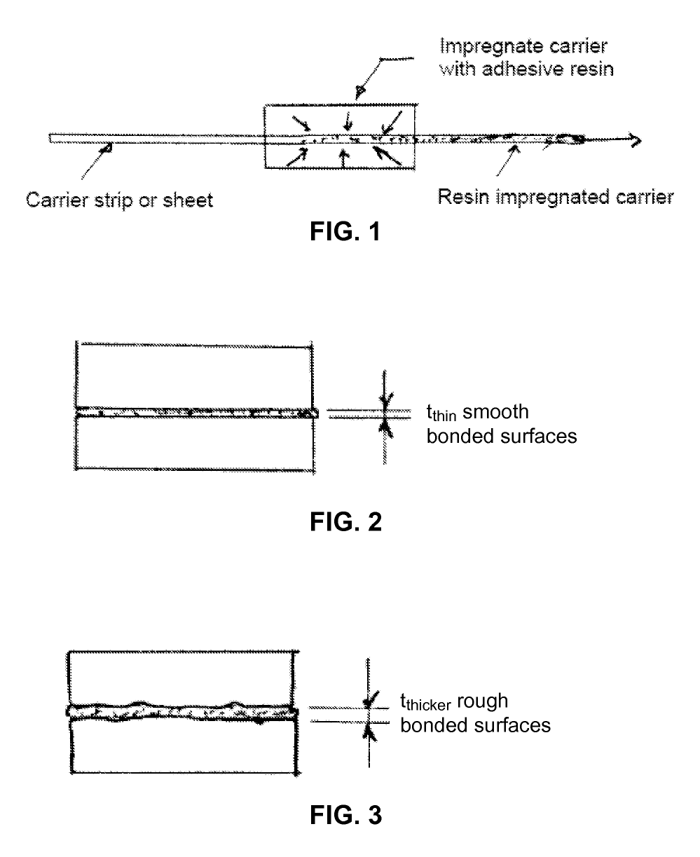

### DETAILED DESCRIPTION OF THE INVENTION

The following description provides non-limiting examples of additional embodiments and explanations of the invention.

As used herein, “continuous” does not require that a non-broken layer of resin is found throughout the carrier. There may be imperfections or areas with no adhesive resin or with an amount of adhesive resin that is more or less than in other areas, as known in the art. As used herein, “uncured adhesive resin” is a material that does not bond until it is cured. “Uncured adhesive resin” does not mean a material which requires pressure to bond. In one embodiment, “uncured adhesive resin” is a water-curable material, such as urethane resins. In one embodiment, “uncured adhesive resin” is curable at room temperature. In one embodiment, “uncured adhesive resin” is a water-curable material that cures at room temperature. In one embodiment, “uncured adhesive resin” is a two part epoxy or one part non-urethane adhesive. If desired, other non water-curable materials can be used as the “uncured adhesive resin.” Additives, such as binders and colorants may be added to the uncured adhesive resin before or after impregnation on the carrier.

The carrier can be composed of any porous substance that can be formed as a flat sheet or strip. Non-limiting examples include a woven or non-woven fabric, a random fibrous mesh, felt, paper, scrim and the like, composed of organic or inorganic material. Since the carrier is intended to function primarily as a support material for uncured adhesive resin, the carrier is preferably highly porous. The carrier need only be strong enough that it does not tear or disintegrate during application, or during the impregnation process.

The adhesive impregnated carrier is semi-compressible such that upon clamping, only a limited amount of adhesive is squeezed out from the joint and to ensure that the bond line thickness does not significantly vary. Under high clamping forces, the carrier becomes non-compressible.

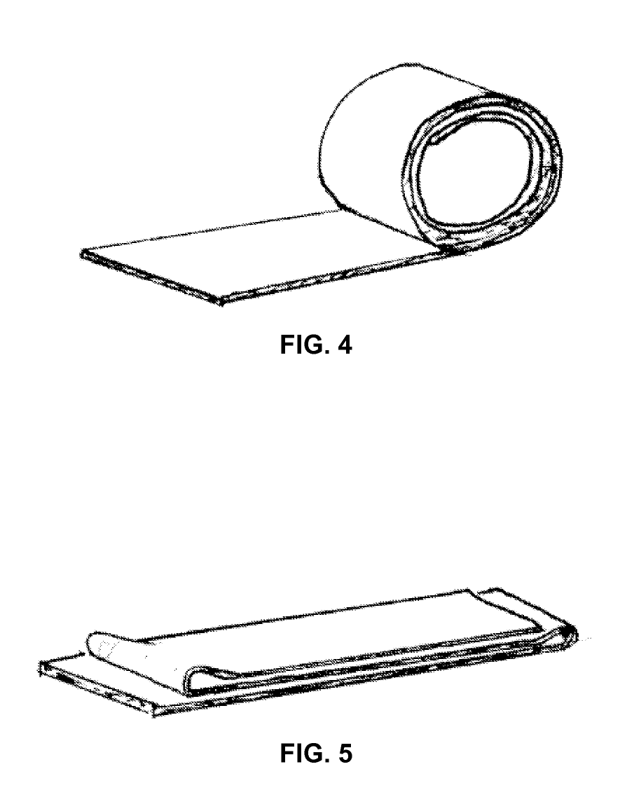

The thickness, t, of the adhesive impregnated fabric is determined by the bond line thickness that the user is seeking to control. A thin carrier material can be used to provide a thin bond line between smooth surfaces (as shown in FIG. 2). A thicker material can be used to accommodate for imperfections of the two surfaces to be bonded (as shown in FIG. 3). Thicknesses are controlled by the choice of the weight or thickness of the carrier. In one embodiment, the adhesive impregnated carrier is between 1/64 inch and 1/16 inch thick.

Carrier material that is non-woven can combine a higher degree of porosity with adequate strength. As a non-limiting example, a thin non-woven material such as Remay, formed by random deposition and compression of short fibers is convenient to use. Resin penetration during impregnation can be improved by needle piercing or multiple perforations of the carrier material, if necessary to obtain the desired amount of impregnation, as easily determined by one of ordinary skill in the art without undue experimentation. The chosen carrier material is preferably wettable by the uncured resin and should not initiate premature curing. In this regard, for example, where the adhesive is a urethane, hygroscopic fibers such as Kevlar should not be used unless a water-scavenging component is included in the resin formulation.

The carrier material can be very thin, because the bond strength depends only on the adhesive itself. In one embodiment, the carrier is between 1/64 inch and 1/16 inch thick.

As a non-limiting example, in a woodworking application where a thin bond line is desired, a thin Remay fabric weighing in the range of 1 oz to 5 oz per square yard, preferably 1.5 oz/sq. yd is suitable, when used with a preferred urethane adhesive as described herein.

A variety of adhesives can be combined with the above-described carrier material, according to the invention. The primary advantages of the invention can be achieved when the carrier material is impregnated with a single-component adhesive that can be packaged so as to prevent contact with, or exposure to substances that initiate curing. Convenient examples include without limitation wood glues, pre-mixed two part epoxies, certain urethane adhesives and methylmethacrylates. Many urethane adhesives expand during curing, a property which is not suitable for applications such as woodworking, where a thin, controlled bond line is desired. Preferred urethanes are those which do not expand significantly during curing, a non-limiting example of which is Bolder Bond™ or which are minimally expansive. In one embodiment, the adhesive expands less than 10% by volume during curing.

The process for combining the uncured adhesive with the carrier material is preferably carried out such that the carrier material is thoroughly impregnated, such that all spaces in, around and between carrier material components are occupied by resin, however, this is not required. In addition, the impregnation process preferably includes a finishing step whereby thickness of the impregnated carrier is controlled to be essentially uniform and resin does not extend beyond the borders of the carrier, but this step is not required. A variety of means for carrying out carrier impregnation are known in the art, such as immersion, spraying, roll-coating, dip-coating, painting, and the like. Carrier impregnation methods may also include methods for controlling temperature, pressure and humidity during impregnation. In one embodiment, the adhesive system is sheared into the carrier material in a humidity-controlled environment using methods known in the art. In one embodiment of shearing, the adhesive is sprayed into an enclosure into which the carrier is passed under conditions which shear the adhesive into the carrier, such as passing the carrier through rods. After the carrier passes through the enclosure, the adhesive is impregnated into the carrier. If urethane adhesives are used, the uncured impregnated carrier can be placed in a bag or container which acts as a water (humidity) barrier after the adhesive is sheared into the carrier. The uncured impregnated carrier can remain uncured for many years, until the water (humidity) catalyst is added when desired. If two-part epoxy resins are used, the adhesive components can be impregnated into the carrier and used in the production line.

The adhesive-impregnated carrier can be packaged in a sealed, air-tight packet that prevents premature curing during storage. Packaging material can be chosen from known materials to provide the necessary storage conditions; for example, exclusion of moisture in the case of a urethane resin. Vacuum packaging can also be employed. Foil packaging provides light, easily stored, easily opened and disposable packaging for a variety of volumes and amounts of product. Strips of impregnated carrier can be individually packaged as rolls (shown in FIG. 4) or in overlapped layers (shown in FIG. 5) of precut length and width in any desired configuration. A variety of pre-cut sizes can be separately sealed and provided as an assortment for household repairs in any convenient combination desired. A set of pre-cut strips, sheets or patches can be provided for use with specific construction projects such as pre-cut furniture, model kits and the like.

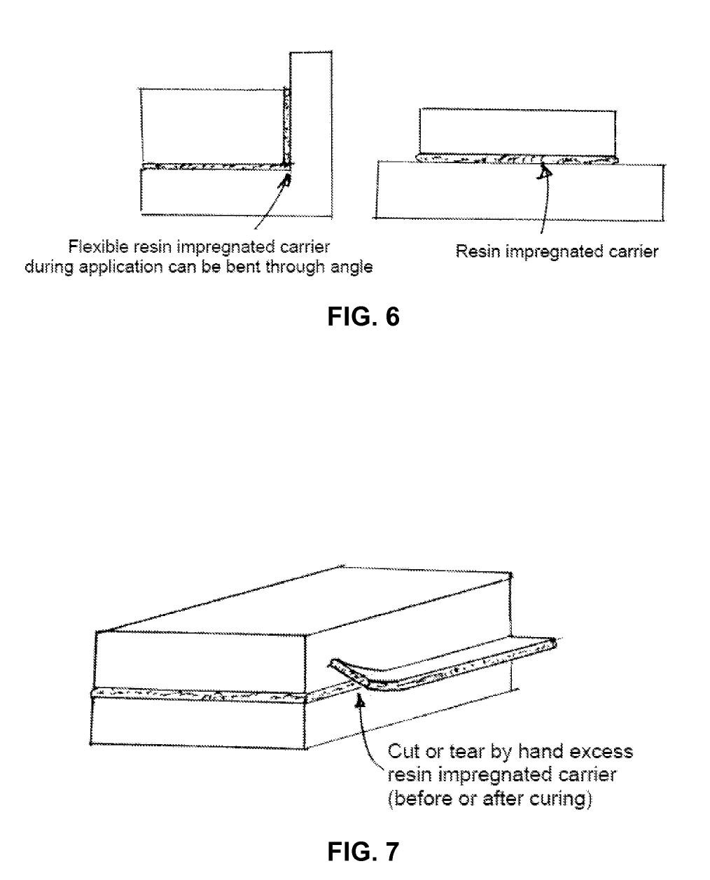

The ease of application of adhesive-impregnated strips is readily apparent. Instead of dispensing an irregular amount of adhesive along a surface to be joined, and subsequently trimming excess adhesive that gets squeezed out between the joined surfaces, a strip of adhesive-impregnated carrier can easily be laid down on one surface and the other surface to be joined can be clamped thereto. Some examples of use are shown in FIG. 6. Any excess carrier can be conveniently removed (as shown in FIG. 7) with a razor or sharp knife or, in the case of certain carriers, torn by hand once cured.

Curing can be initiated by means appropriate for the adhesive resin component, as easily determined by one of ordinary skill in the art without undue experimentation. For example, where the resin is a urethane, water can be applied from a spray bottle to the carrier strip, or the strip can be “activated” by dipping in water or passing over a wet roller or mandrel. Water can also be applied to the surface area that the carrier strip is bonded to.

The package of adhesive impregnated carrier may include directions for use. Typical directions for use of a urethane-impregnated carrier are as follows:

1. Prepare the surface to be bonded and moisten with water. Note that alternate methods can be used to cure the urethane impregnated carrier such as applying water to carrier upon removal from the packaging envelope.
2. Open sealed packaging and remove carrier strip.
3. Place carrier strip on one of the surfaces to be bonded and apply water to the carrier using a spray bottle or wet cloth if prepared surfaces were not moistened previously.
4. Place the second surface to be bonded directly on the carrier and press together. A clamping force is the preferred method of holding the connection together until the adhesive carrier is fully cured. The clamping force is not required to cure the adhesive carrier, but only used to control the bond line thickness and contact surface areas.

This technique of applying adhesives allows the user to control the bond line thickness, is not messy to use and eliminates the need to manage clogged dispensers.

Every formulation or combination of components described or exemplified can be used to practice the invention, unless otherwise stated. Specific names of compounds are intended to be exemplary, as it is known that one of ordinary skill in the art can name the same compounds differently. One of ordinary skill in the art will appreciate that methods, device elements, and starting materials other than those specifically exemplified can be employed in the practice of the invention without resort to undue experimentation. All art-known functional equivalents, of any such methods, device elements and starting materials are intended to be included in this invention. Whenever a range is given in the specification, for example, a temperature range or a thickness range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In general the terms and phrases used herein have their art-recognized meaning, which can be found by reference to standard texts, journal references and contexts known to those skilled in the art. The definitions are provided to clarify their specific use in the context of the invention.

All patents and publications mentioned in the specification are indicative of the levels of skill of those skilled in the art to which the invention pertains.

One skilled in the art would readily appreciate that the present invention is well adapted to carry out the objects and obtain the ends and advantages mentioned, as well as those inherent therein. The adhesive compositions, carrier materials, and curing methods described herein as presently representative of preferred embodiments are exemplary and are not intended as limitations on the scope of the invention. Changes therein and other uses will occur to those skilled in the art, which are encompassed within the spirit of the invention, are defined by the scope of the claims.

Although the description herein contains many specificities, these should not be construed as limiting the scope of the invention, but as merely providing illustrations of some of the embodiments of the invention. Thus, additional embodiments are within the scope of the invention and within the following claims. All references cited herein are hereby incorporated by reference to the extent that there is no inconsistency with the disclosure of this specification. Some references provided herein are incorporated by reference herein to provide details concerning additional useful materials and additional uses of the invention.

I claim:

1. An adhesive impregnated carrier comprising a carrier impregnated with uncured adhesive resin.

2. The carrier of claim 1, wherein the adhesive resin is water-curable.

3. The carrier of claim 1, wherein the adhesive resin is curable at room temperature.

4. The carrier of claim 1, wherein the carrier is selected from the group consisting of: woven fabric, non-woven fabric, fibrous mesh, felt, paper, and scrim.

5. The carrier of claim 1, wherein the adhesive resin is selected from the group consisting of: wood glue, urethane adhesive, pre-mixed two part epoxies and methylmethacrylates.

6. The carrier of claim 1, wherein the adhesive resin expands less than 10% by volume during curing.

7. The carrier of claim 1 further comprising a barrier surrounding the carrier.

8. The carrier of claim 8, wherein the barrier is a moisture-resistant package.

9. The carrier of claim 7, wherein the barrier is a foil-lined package.

10. A method of bonding materials together comprising:
positioning an uncured adhesive impregnated carrier between materials to be bonded;
curing the adhesive impregnated carrier, wherein the materials are bonded.

11. The method of claim 10, wherein the adhesive is water-curable.

12. The method of claim 10, wherein the adhesive is curable at room temperature.

13. The method of claim 11, wherein the curing step comprises moistening the surfaces to be bonded.

14. The method of claim 11, wherein the curing step comprises moistening the carrier.

15. The method of claim 10, wherein the carrier comprises a carrier impregnated with uncured adhesive resin.

16. The method of claim 15, wherein the carrier is selected from the group consisting of: woven fabric, non-woven fabric, fibrous mesh, felt, paper, and scrim.

17. The method of claim 10, wherein the adhesive is selected from the group consisting of: wood glue, urethane adhesive and methylmethacrylates.

18. A method of preparing an adhesive impregnated carrier comprising:
impregnating a carrier with uncured adhesive resin under conditions where the adhesive resin is impregnated with adhesive resin.

19. The method of claim 18, wherein the carrier is selected from the group consisting of: woven fabric, non-woven fabric, fibrous mesh, felt, paper, and scrim.

20. The method of claim 19, wherein the adhesive is selected from the group consisting of: wood glue, urethane adhesive and methylmethacrylates.
